(19) United States
(12) Patent Application Publication
(10) Pub. No.: US 2024/0054855 A1
(43) Pub. Date: Feb. 15, 2024

(54) Moneyline Jackpot

(71) Applicant: James Darnell Mills, JR., Sicklerville, NJ (US)

(72) Inventor: James Darnell Mills, JR., Sicklerville, NJ (US)

(21) Appl. No.: 17/887,467

(22) Filed: Aug. 14, 2022

(51) Int. Cl. G07F 17/32

(52) U.S. Cl. CPC G07F 17/323; G07F 17/329; G07F 17/3258

(57) ABSTRACT

An automated system for lottery application is provided which allows the players to choose the best options based on past statistic and other methods. The system displays the underdogs, stars and provides various other novel features which are innovative in nature.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, hut otherwise reserves all copyright rights whatsoever.

### BACKGROUND

### Field of the Invention

The present invention relates to a method and apparatus for betting in a lottery. More particularly, the invention relates to a method and apparatus for lottery application that works like sports betting.

### Description of the Related Art

Betting or lottery games are well known where players place a bet on the outcome of an event, such as a random selection of numbers, objects or other clues, and the bet is won or lost depending on the outcome of the game. event. For example, in a typical lottery game such as a take 3 game or take 4, the Participants can place a bet and designate particular shots of a number field or other indications. Alternatively, the player may act for a random generation of his shots. The game authority can randomly generate (for example, through a mechanical, electrical or software generation, and the like) a “winning” game of numbers from the field, and a player “win” if their selections equal all or some combination of the winning numbers.

The bonus features have been introduced in the lottery games to make the games more attractive to the players. In a typical scenario, the player buys the bonus feature option by placing the initial bet for the lottery game. If the player wins a prize amount in the game, the bonus feature may increase the amount of the prize by a predetermined factor, or a randomly generated factor that is determined at the time of the lottery game. A well-known version of this concept is the Powerball Lottery Game Registered Trademark with the Power Play option.

The Powerball Lottery Game is a game with a jackpot game where and combined and a cash game. Each ticket costs $1. Five white balls out of a drum with 55 numbered balls and one red ball out of a drum with 42 numbered red balls drawn by the game authority. Players win by doing Match one of nine possible winning combinations. The jackpot is won by matching all five white balls in one order and the PowerBall Red Registered Mark. The second prize in cash is won by matching five white balls in any order. A player also wins a cash prize any time he equals the PowerBall Red Registered Mark. The Power Play option is a special feature that allows the winner to multiply the original prize amount by 2, 3, 4 or 5 times (does not include the jackpot). The game authority takes the Power Play multiplier number at random in each lottery draw. The player must choose the Power Play option when he buys his PowerBall Registered Trademark ticket, and then the ticket must win one of the jackpots that are a jackpot before the multiplier takes effect.

U.S. Pat. Nos. 6,416,408; 6,648,753 and 6,692,354 describe several group betting games where the participants make a first bet on a first game and a second bet on the result of a second group game. The result of the second group game is determined first, but it is only applied if the first game is a winner. Therefore, a round of “bonus” game is provided to the winners of the first game.

The industry is continuously looking for ways, to generate a group interest and excitement in the game experience. The present invention provides a unique feature and an associated system in this regard. It is a new type of application which works in similar way as a betting application works. It picks multiple options and gives implied probabilities of selected options.

SYNTHESIS The objects and advantages of the invention will be set forth in part in the following description, or may be obvious from the description or may be learned through the practice of the invention. In accordance with aspects of the present invention, an associated methodology system is provided to carry out a lottery betting game of the type wherein the game is presented to a plurality of players and allows to choose the options with higher probabilities.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of he disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The objective of the invention is to provide an improved system and procedure which automatically calculates the probabilities and provide results.

More specifically, it is the principal object of this invention to provide a virtual environment system which is both interactive, and responsive to a user's prompting by any one of a number of commands or input and provides probabilities of winning of a player.

It is also the objective of the system to provide a system where the built-in calculator provides various features including but not limited to bet amount setting and display, net profit and total payout features.

It is also a feature of the invention to provide a calendar which shows real-time statistics of selected picks.

It is also the objective of the invention to provide methodology where favorites are indicated by minus sign and under dogs are indicated by plus sign.

According to another aspect of the invention, it is also the object of invention to provide an online application which is available on almost all smartphones or tablets.

According to another aspect of the invention, the game is application to play and its interactive and attractive interface makes the user rise it easily.

Other aspects, advantages and novel features of the present ion will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows view of application incorporating the embodiments of invention.

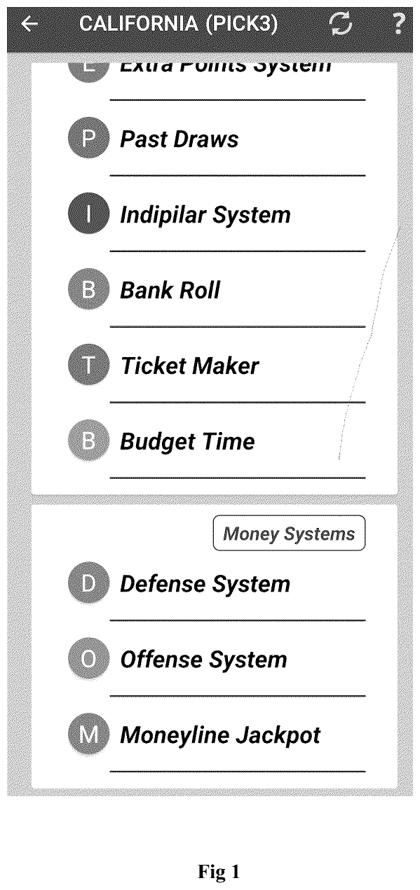

FIG. 2 shows another view of application incorporating the embodiments of invention.

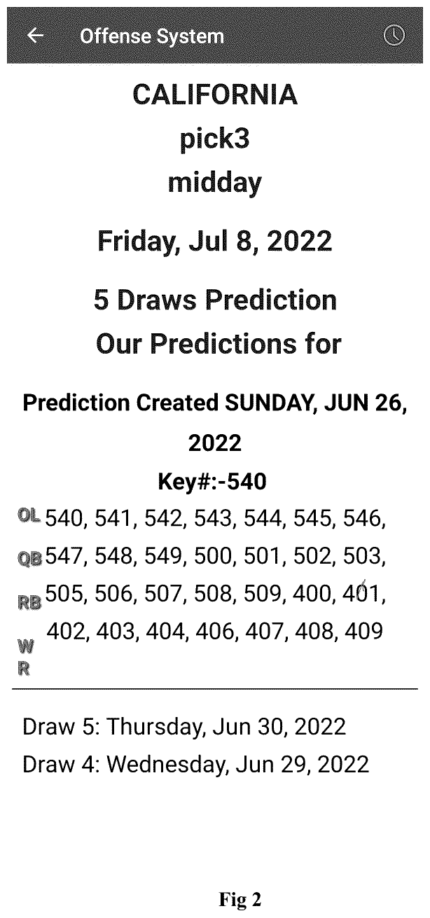

FIG. 3 shows calculator view of application incorporating the embodiments of invention.

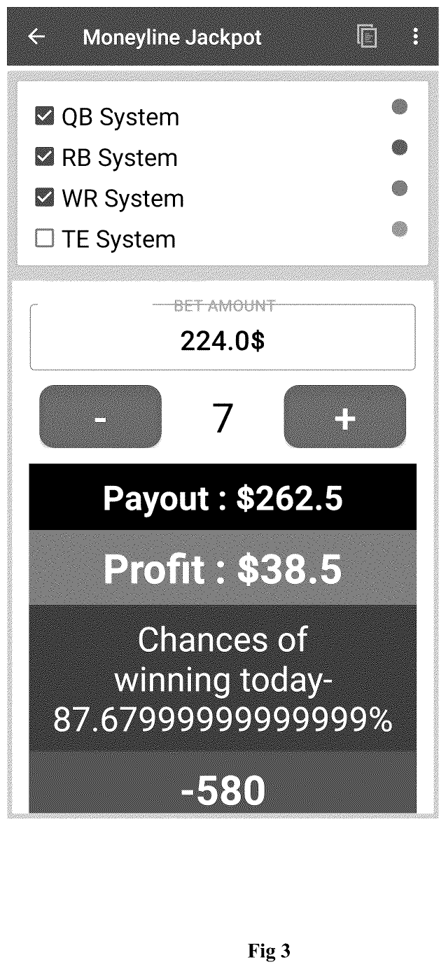

FIG. 4 shows the probabilities display incorporating the embodiments of invention.

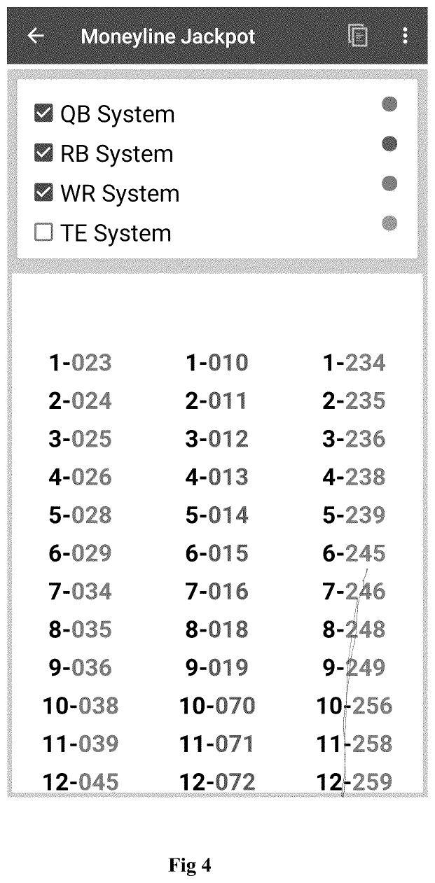

The apparatus and method components have been represented where appropriate by conventional symbols in the drawings, showing only those specific details

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an application that presents an advancement in Casino/lottery games.

Moneyline jackpot app as per its preferred embodiments is the lottery application that works the same way sports betting works. It includes a pick 3 and pick 4 system app which provides implied probabilities of the selected systems which user selects.

As per its preferred embodiments the application includes four systems for pick 3 and pick 4 which both use the same method. The more systems users choose the higher implied probabilities will be. User can select one system or can select all four systems at once. The higher probabilities user has the higher chances of winning in a draw.

The lottery application, as per its preferred embodiments let user selects the systems, he/she wants to use if you choose the underdog systems or favorite to win. The app automatically calculates the probabilities and displays how much of an underdog or favorite you are. It also shows the bet amount that's needed for selection. It has a built-in calculator so user can see bet amount, net profit and total payout if you win. It's very easy for lottery players to use because they can see their chances of winning immediately and they know exactly how much it cost and know the profit and expected payout.

As per its preferred embodiments it also shows calendar statistic that shows the history of selected picks for the past year. The Moneyline jackpot also displays the underdog systems for big payout.

As per its further embodiments, the moneyline shows a straight up bet on the outcome of a game. The favorite is always indicated by a minus sign G), and the underdog is indicated by a plus sign (+). In the case of the favorite, the moneyline is the amount a better would have to wager to win $300. For the underdog, the moneyline is the amount a better stand to win if they were to wager $300.

The Moneyline jackpot, as per its further embodiments includes innovative features including built in moneyline calculator and Extra point system which automatically generates numbers from the defense and offense system giving players a few bonus numbers to play

The Defense system as per its further embodiments generates numbers when a combination of things happens it will then create key numbers example pick 3 it will automatically generate 28 numbers. Those 28 numbers will be the prediction numbers for 5 draws. So, if the numbers are generated on Jul. 5, 2022. The predictions will be thru Jul. 10, 2022 after that we don't track the system. Now this system is set up in American football fashion. Pick 3 has four lines of 7 numbers. Each line has an initial of the position of the real sport.

For pick 3
First line is DL
Second line is—DE
Third line is LB
Fourth line is FS
DL is short for Defense of Line
DE is short for defensive End
LB is short for Linebacker FS is short for Free Safety
DT is short for defensive tackle
CB is short for cornerback FS is short for free safety

For pick 4 the system generates 40 numbers. There is 6 lines each has 6 numbers except FS line. It has 8. Now for pick 4 its two extra lines/positions because it's more numbers

### DE

### LB

### CB

The system as per its further embodiments tracks both the 5 draw predictions and tracks the positions that comes out. It also displays the history of the 5-day predictions and the positions that came out. This system provides added utility by saving players money because they don't have to play all the numbers in the system. They can check the history and play the numbers on their favorite positions.

The system as per its further embodiments provides Defense system which is predictions not generated every day. But when it does generate the group of numbers. The user can play all or favorite position for the lottery game. The best feature of defense system predictions are not generated every day only when many key factors from the app happen. Then it will automatically generate the 5 draw predictions.

The system as per its further embodiments provides offense system is very unique. The system generates numbers a combination of things happens it will then create key numbers example pick 3 it will automatically generate 28 numbers. Those 28 numbers will be the prediction numbers for 5 draws. So, if the numbers are generated on Apr. 5, 2022. The predictions will be thru Apr. 10, 2022 after that we don't track the system. Now this system is set up in American football fashion. Pick 3 has four lines of 7 numbers. Each line has an initial of the position of the real sport.

For pick 3
First line is OL
Second line is—QB
Third line is RB
Fourth line is WR
OL is short for offensive Line
QB is short for quarterback
RB is short for running back
WR is short for wide receiver
FB is short for fullback
TE is short for Tight end

For pick 4 the system generates 40 numbers. There is 6 lines each has 6 numbers except WR line. It has 8. Now for pick 4 its two extra lines/positions because it's more numbers

### QB

### WR

The system as per its further embodiments tracks both the 5 draw predictions and we track the positions that comes out. It also shows the history of the 5-day predictions and the positions that came out. This system saves players money because they don't have to play all the numbers in the system. They can check the history and play the numbers on their favorite positions.

The system as per its further embodiments, includes multiple benefits of Defense system which includes predictions which not generated every day. It generates the group of numbers. User can play all or favorite position for the lottery game. And it's a 5 draw cut off so players have a limit, and will never over spend. The great thing about defense system predictions are not generated every day only when many key factors from the app happen. Then it will automatically generate the 5 draw predictions.

The system as per its further embodiments provides Bankroll feature which includes automatically calculating for you how much to play each draw. The user can simply enter full amount of money. It will then divide what you entered by 4. Then you select the growth speed. Which is set at Normal growth, fast growth, Super-fast growth. The difference is the percentage of you money you would like to play with. Normal growth is set at 6% fast growth is set at 8% and Superfast is set at 10% when gambling in any sports you always need a bankroll management.

The system as per its further embodiments provides Budget time feature which is for when you have any amount of money you want to budget. Its breaks it down in days weeks months and years. User can simply enter the amount and how long he/she want it to last. It then will calculate how much user need to spend every day week month or year. User can clearly see how much he/she can spend.

The system as per its further embodiments provides Ticket maker feature which includes a lottery pool with friends and family. User can just simply enter all the names for the lottery pool and it will also divide all the numbers between each player. The first on the list will get the extra numbers to play.

The system as per its further embodiments provides Prediction date feature which adds how many times an event happened in the past year and enter the last time it came out. It will then give the prediction date for that particular event to come back out.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A system lottery application where a pick 3 and pick 4 system gives implied probabilities of the selected systems comprising features:
As per claim 1, automatic calculation of probabilities;
As per claim 1, automatic display of selected options underdog or favorite status; and,
As per claim 1, automatic display of calendar statistics to shows the history of selected picks for the past year/s;

2: A Moneyline jackpot system with 4 systems and built in moneyline calculator.

3: A Moneyline jackpot system wherein extra point system automatically generates numbers from defense and offense system and gives players a few bonus numbers to play.

4: A unique defense system which generates the group of numbers. User can play all or r favorite position for the lottery game and it's a 5-draw cut off so players have a limit. The defense system predictions will automatically generate the 5 draw predictions.

5: A Moneyline jackpot system with Bankroll feature allowing to automatically calculate for user how much to play each draw. User can imply enter full amount of money and it will then divide what user entered by 4. Then user can select the growth speed which can be Normal growth, fast growth, Super-fast growth.

6: The Budget time feature is when user have any amount of money, he/she want to budget. Its breaks it down in days weeks months and years. User can simply enter amount and how long you want it to last. It then will calculate how much user need to spends every day week month or year.
